(19) United States
(12) Patent Application Publication
(10) Pub. No.: US 2008/0302461 A1
(43) Pub. Date: Dec. 11, 2008

(54) Transparent Colored High Modulus Interlayers and Laminates Therefrom

(75) Inventors: Richard Allen Hayes, Beaumont, TX (US); Thomas R. Phillips, Vienna, WV (US); Sam Louis Samuels, Landenberg, PA (US); Rebecca L. Smith, Vienna, WV (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 11/760,468

(22) Filed: Jun. 8, 2007

(51) Int. Cl. B32B 17/10; C08L 67/00

(52) U.S. Cl. 156/99; 524/556

(57) ABSTRACT

A process for preparing a transparent laminate comprising a colored interlayer and a rigid sheet, comprising: (a) forming a color concentrate comprising a thermoplastic ionomer copolymer and about 1 to about 10 wt % (based on the total weight of the color concentrate) of pigment by: (i) combining (a) one or more colored master batch, each comprising about 50 to about 80 wt % (based upon the weight of the master batch) a thermoplastic matrix polymer and about 20 to about 50 wt % (based on the weight of the master batch) of pigment, and (b) one or more thermoplastic ionomer copolymer; and (ii) melt mixing the one or more colored master batch and the one or more thermoplastic ionomer copolymer at a temperature above the melting points of the thermoplastic ionomer copolymer and the thermoplastic matrix polymer; (b) forming an interlayer composition comprising thermoplastic ionomer copolymer and about 0.01 to about 3 wt % (based upon the weight of the thermoplastic ionomer copolymer and pigment in the interlayer composition) pigment by: (i) combining the color concentrate and thermoplastic ionomer copolymer; and (ii) melt mixing the color concentrate and the thermoplastic ionomer copolymer at a temperature above the melting point of the thermoplastic ionomer copolymer; and (c) forming a colored thermoplastic interlayer sheet comprising thermoplastic ionomer copolymer and about 0.01 to about 3 wt % (based upon the weight of the ionomer and pigment in the interlayer) pigment by extruding the interlayer composition into the interlayer sheet; and (d) preparing a laminate comprising the colored thermoplastic interlayer and a rigid sheet; wherein by thermoplastic ionomer copolymer is meant a thermoplastic copolymer of an alpha-olefin having 2 to 10 carbon atoms and about 15 to about 30 wt % (based on the total weight of the ionomer copolymer) of an alpha, beta-ethylenically unsaturated carboxylic acid having 3 to 8 carbons, wherein about 5 to about 90% of the carboxylic acids are neutralized with a metal ion. In addition, ionomer/pigment master batch.

### FIELD OF THE INVENTION

The invention relates to transparent laminate articles comprising transparent colored interlayer sheet which maintain the safety aspects commonly associated with safety glass, and the processes and compositions to produce same.

### BACKGROUND OF THE INVENTION

Glass laminated products have contributed to society for almost a century. Beyond the well known, every day automotive safety glass used in windshields, laminated glass is used in all forms of the transportation industry. It is utilized as windows for trains, airplanes, ships, and nearly every other mode of transportation. Safety glass is characterized by high impact and penetration resistance and does not scatter glass shards and debris when shattered. More recently it has found many uses in structural, decorative or other architectural applications, such as windows, stairs, displays and other articles for buildings.

Safety glass typically consists of a sandwich of two glass sheets or panels bonded together with an interlayer of a polymeric film or sheet, which is placed between the two glass sheets. One or both of the glass sheets may be replaced with optically clear rigid polymeric sheets, such as sheets of polycarbonate materials. Safety glass has further evolved to include multiple layers of glass and polymeric sheets bonded together with interlayers of polymeric films or sheets.

The interlayer is typically made with a relatively thick polymer film or sheet, which exhibits toughness and bondability to provide adhesion to the glass in the event of a crack or crash. Over the years, a wide variety of polymeric interlayers have been developed to produce laminated products. In general, these polymeric interlayers must possess a combination of characteristics including very high optical clarity, low haze, high impact resistance, high penetration resistance, excellent ultraviolet light resistance, good long term thermal stability, excellent adhesion to glass and other rigid polymeric sheets, low ultraviolet light transmittance, low moisture absorption, high moisture resistance, excellent long term weatherability, among other requirements. Architectural and automotive glazings are being constantly upgraded to withstand manmade and natural threats.

Poly(vinyl acetal) interlayers, particularly poly(vinyl butyral) interlayers, have been the most common interlayers used in automobile windshields and buildings. Colored laminates containing poly(vinyl butyral) interlayer are known and can be produced using colored glass, colored interlayers such as DuPont™ Butacite® poly(vinyl butyral) interlayers (see, e.g., DuPont™ Butacite® Polyvinyl butyral Interlayers product brochure, http://www.dupont.com/safetyglass/en/productServices/butacite/butacite brochure.pdf), or through use of colored films adhered to the laminates. The use of pigment concentrates in poly(vinyl butyral) interlayer for glass laminates is described in WO 01/00404 and US 2006/0269739. These interlayers, however, do not have suitable properties for “threat” resistant safety glass used in hurricane regions and other architectural uses, or other applications that can benefit from improved structural properties.

Thermoplastic ionomeric copolymers have now found significant use in interlayer sheets, such as DuPont™ SentryGlas® Plus interlayer sheets and DuPont™ SentryGlas® Acoustic™ interlayer sheets, for threat resistant safety laminate and glass laminates for other applications. See, e.g., U.S. Pat. No. 3,344,014, U.S. Pat. No. 3,762,988, U.S. Pat. No. 4,663,228, U.S. Pat. No. 4,668,574, U.S. Pat. No. 4,799,346, U.S. Pat. No. 5,759,698, U.S. Pat. No. 5,763,062, U.S. Pat. No. 5,895,721, U.S. Pat. No. 6,150,028, U.S. Pat. No. 6,432,522, U.S. Pat. No. 7,165,362, US 2002/0155302 and US 2006/0182983.

Recently there has been a desire for colored threat resistant safety glass laminates with high transparency to maintain the desirable clarity demanded of automotive and architectural glazings. However, suitable colored glass laminates have not been available and, while adding dyes and pigment to ionomer copolymers is described, suitable transparent colored ionomer interlayers have not been described, and the methods described for adding color to ionomer copolymers have been found insufficient to prepare colored transparent ionomer interlayers.

For example, blends which incorporate ionomers have been dyed, see, for example U.S. Pat. No. 4,732,571, U.S. Pat. No. 4,802,886 and U.S. Pat. No. 4,872,880, but dyes suffer the shortcoming of reduced weathering performance and tend to fade upon outdoor light exposure.

Bennison, et. al., in WO 99/58334, states that typical colorants that can be used in ionomer resin sheet are, for example, a bluing agent to reduce yellowing, a whitening agent, or a colorant to color the glass or to control solar light.

US 2002/0055006, US 2005/0074622, US 2005/0074623, and US 2005/0106386 describes use of pigments and pigment concentrates in making ionomeric surfaced film and sheet and articles (e.g., automotive panels and parts). These parts are opaque and the processes described therein include difficult common art pigment dispersion processes such as sand grinding, ball milling, attritor grinding or two-roll milling.

In addition, use of pigments in ionomers for golf balls is known, such as described in U.S. Pat. No. 6,100,336.

Smith, et. al., in US 2005/0282962 and US 2006/0003177, disclose a process to produce ionomeric pigment concentrates and multilayer films which incorporate them. This process suffers the shortcoming of being inefficient, requiring the steps of forming a pigment slurry through a high shear process, mixing the pigment slurry with the carrier resin, and drying and grinding the resulting mixture.

A more efficient process to produce finely divided and dispersed pigment concentrates includes high shear melt blending of 20-45 weight percent pigment in a carrier resin. Traub, in U.S. Pat. No. 3,418,270 discloses a process to produce polyolefin (selected from ethylene homopolymers and copolymers of ethylene with alpha-olefin having from 3 to 12 carbon atoms) pigment compositions by preparing a composition containing 20 to 45 weight % pigment, preferably carbon black. This process makes it difficult to prepare a wide variety of colors and is not well suited to make products with high clarity.

Hence, there is a need for a colored laminate with suitable properties for “threat” resistant safety glass and for other architectural uses, or other applications that can benefit from improved structural properties, and for suitable process for making such laminates. The invention overcomes these shortcomings and provides colored safety glass laminates with good transparency and low haze, which provide the added safety and structural aspects desired.

### SUMMARY OF THE INVENTION

The invention is directed to a process for preparing a transparent laminate comprising a colored interlayer and a rigid sheet. The process comprises steps (a) to (d) in sequence. Step (a) is forming a color concentrate comprising a thermoplastic ionomer copolymer and about 1 to about 10 wt % (based on the total weight of the color concentrate) of pigment by: (i) combining (a) one or more colored master batch, each comprising about 50 to about 80 wt % (based upon the weight of the master batch) a thermoplastic matrix polymer and about 20 to about 50 wt % (based on the weight of the master batch) of pigment, and (b) one or more thermoplastic ionomer copolymer; and (ii) melt mixing the one or more colored master batch and the one or more thermoplastic ionomer copolymer at a temperature above the melting points of the thermoplastic ionomer copolymer and the thermoplastic matrix polymer. In addition to the ionomer and pigment, the color concentrate can have 0 to 5 weight %, preferably 0 to 2 weight %, additives. (The additives may be present in one or more of the master batch(es), or be added separately or through use of another master batch.) If the thermoplastic matrix polymer comprises polymer(s) other than ionomer, then those polymer(s) will also be present in a corresponding amount. Thus, the color concentrate comprises or consists essentially of the ionomer, pigment, additives and, optionally, the other matrix polymer. Optionally, the product can be pelletized and melt compounded. Step (b) is forming an interlayer composition comprising about 97 to about 99.9 wt % (based upon the weight of the ionomer and pigment in the interlayer composition) thermoplastic ionomer copolymer and about 0.01 to about 3 wt % (based upon the weight of the thermoplastic ionomer copolymer and pigment in the interlayer composition) pigment by: (i) combining the color concentrate and thermoplastic ionomer copolymer; and (ii) melt mixing the color concentrate and the thermoplastic ionomer copolymer at a temperature above the melting point of the thermoplastic ionomer copolymer. In addition to the ionomer and pigment, the interlayer composition can have 0 to 5 weight %, preferably 0 to 2 weight %, additives. If the thermoplastic matrix polymer comprises polymer(s) other than ionomer, then those polymer(s) will also be present in a corresponding amount. Thus, the interlayer composition comprises or consists essentially of the ionomer, pigment, additives and, optionally, the other matrix polymer. Optionally, the product can be pelletized and melt compounded. Step (c) is forming a colored thermoplastic interlayer sheet comprising thermoplastic ionomer copolymer and about 0.01 to about 3 wt % (based upon the weight of the ionomer and pigment in the interlayer) pigment by extruding the interlayer composition into the interlayer sheet. In addition to the ionomer and pigment, the colored thermoplastic interlayer sheet can have 0 to 5 weight %, preferably 0 to 2 weight %, additives. If the thermoplastic matrix polymer comprises polymer(s) other than ionomer, then those polymer(s) will also be present in a corresponding amount. Thus, the interlayer sheet comprises or consists essentially of the ionomer, pigment, additives and, optionally, the other matrix polymer. Generally, the interlayer composition will have lower percentage of pigment than the color concentrate, typically at least an order of magnitude smaller, i.e., preferably a ratio of pigment in interlayer composition:pigment in concentrate of greater than or equal to about 1:10. Step (d) is preparing a laminate comprising the colored thermoplastic interlayer and a rigid sheet. By thermoplastic ionomer copolymer is meant a thermoplastic copolymer of an alpha-olefin having 2 to 10 carbon atoms and about 15 to about 30 wt % (based on the total weight of the ionomer copolymer) of an alpha, beta-ethylenically unsaturated carboxylic acid having 3 to 8 carbons, wherein about 5 to about 90% of the carboxylic acids are neutralized with a metal ion.

In one preferred embodiment, the thermoplastic matrix polymer is a thermoplastic ionomer copolymer of an alpha-olefin having 2 to 10 carbon atoms and about 15 to about 30 wt % (based on the total weight of the ionomer copolymer) of an alpha, beta-ethylenically unsaturated carboxylic acid having 3 to 8 carbons, wherein about 5 to about 90% of the carboxylic acids are neutralized with a metal ion.

In one preferred embodiment, the thermoplastic matrix polymer is poly(vinyl acetal), preferably poly(vinyl butyral).

In one preferred embodiment:
the color concentrate consists essentially of (I) about 90 to about 99 wt % (based on the total weight of the ionomer and pigment in the color concentrate) of an thermoplastic ionomer copolymer, (II) about 1 to about 10 wt % (based on the total weight of the ionomer and pigment in the color concentrate) of pigment, and (III) 0 to about 5 wt % (based on the total weight of the color concentrate) optional additives.
the interlayer composition consists essentially of (I) about 97 to about 99.9 wt % (based upon the weight of the ionomer and pigment in the interlayer composition) thermoplastic ionomer copolymer, (II) about 0.01 to about 3 wt % (based upon the weight of the ionomer and pigment in the interlayer composition) pigment, and (III) 0 to about 5 wt % (based on the total weight of the interlayer composition) optional additives; and
the colored thermoplastic interlayer sheet consists essentially of (I) about 97 to about 99.9 wt % (based upon the weight of the ionomer and pigment in the interlayer) thermoplastic ionomer copolymer, (II) about 0.01 to about 3 wt % (based upon the weight of the ionomer and pigment in the interlayer) pigment by extruding the interlayer composition into the interlayer sheet, and (III) 0 to about 5 wt % (based on the total weight of the colored thermoplastic interlayer sheet of optional additives.

In a preferred embodiment, (a) the interlayer composition comprises about 0.1 to about 2 weight % pigment (preferably about 0.01 to about 0.5 weight %), based on the weight of the interlayer composition, (b) the colored interlayer comprises about 0.1 to about 2 weight % (preferably about 0.01 to about 0.5 weight %) pigment, based on the weight of the colored thermoplastic interlayer, and (c) the color concentrate comprises about 0.3 to about 5 weight % pigment, based on the weight of the color concentrate.

The pigment primary particle diameter size is preferably between about 1 to about 200 nanometers (nm), more preferably between about 10 to about 100 nm.

Preferably the laminates have about 20% to 100% transmission. (ASTM D1003.)

Preferably the laminate has about 90 to 100% clarity. (ASTM D1003.)

Preferably the laminate has about 95 to 100% clarity. (ASTM D1003.)

Preferably each of the melt mixing steps is conducted at a temperature from about 110° C. to about 250° C., more preferably about 180° C. to about 250° C.

In a preferred embodiment, the colored thermoplastic interlayer is adhered directly to the rigid sheet.

The rigid sheet is preferably glass lite or sheet or polycarbonate, most preferably glass, and is preferably primed with an adhesive material, which is preferably selected from the group consisting of silanes and poly(alkyl amines). In a preferred embodiment, the rigid sheet is a glass sheet.

In a preferred embodiment, the preparing a laminate comprising the colored thermoplastic interlayer and a rigid sheet comprises forming a pre-laminate assembly of the colored thermoplastic interlayer between the rigid sheet and a second rigid sheet, and laminating the pre-laminate assembly using heat.

In another preferred embodiment, the preparing a laminate comprising the colored thermoplastic interlayer and a rigid sheet comprises forming a pre-laminate assembly of the colored thermoplastic interlayer and at least one other interlayer sheet between the rigid sheet and a second rigid sheet, and laminating the pre-laminate assembly using heat. The at least one other interlayer sheets is preferably selected from the group consisting of acid copolymers, thermoplastic ionomer copolymers, poly(ethylene-co-vinyl acetate), poly(vinyl acetal), polyurethane, polyvinylchloride, polyethylenes, polyolefin block elastomers, ethylene acrylate ester copolymers, silicone elastomers and epoxy resins.

In yet another preferred embodiment, the laminate is formed by forming a pre-laminate assembly comprising in order the rigid sheet, the colored thermoplastic interlayer, a polyester film, a second interlayer sheet and a second rigid sheet, and laminating the pre-laminate assembly using heat. The laminate may have other layers such as adhesive or binder layers.

In a further preferred embodiment, the laminate is formed by forming a pre-laminate assembly comprising in order the rigid sheet, the colored thermoplastic interlayer, a polyester film, and laminating the pre-laminate assembly using heat. The rigid sheet is preferably glass lite or sheet or polycarbonate, most preferably glass, and is preferably primed with an adhesive material, which is preferably selected from the group consisting of silanes and poly(alkyl amines). The polyester film is preferably treated on the side closest to the colored thermoplastic interlayer, preferably with poly(alkyl amine) and most preferably poly(allyl amine). The polyester film is preferably poly(ethylene terephthalate) and is preferably a biaxially oriented film. Preferred a biaxially-oriented poly(ethylene terephthalate film.

In a preferred embodiment, the colored thermoplastic interlayer is in the form of a monolayer sheet with a thickness of about 10 to about 250 mils (0.25-6.35 mm).

In a preferred embodiment, the thermoplastic ionomer copolymer is prepared from (a) an alpha olefin selected from the group consisting of ethylene, propylene, 1-butene, 1-pentene, 1-hexene, 1-heptene, 3-methyl-1-butene, 4-methyl-1-pentene and mixtures thereof, and (b) an alpha, beta-ethylenically unsaturated carboxylic acid comonomer selected from the group consisting of acrylic acid, methacrylic acid, itaconic acid, maleic acid, maleic anhydride, fumaric acid, monomethyl maleic acid and mixtures thereof. Preferably the thermoplastic ionomer copolymer is prepared from (a) ethylene and (b) acrylic acid, methacrylic acid or mixtures thereof.

In a preferred embodiment, the pigment is selected from the group consisting of (Color Index nomenclature) PB 60, PR202, PR264, PY151, PB 15.3, PR 122, PV 19, PY181, PV19, PR254, PV 15.1, PG 7, PB29, PB15.6, PY129, PY109, PY42, PB7, PB15:4, DPP/QA pigment, PR209, PR202, PR149 and combinations thereof. Preferably the pigment is selected from the group consisting of PY42, PB7, PB1 5:4, DPP/QA pigment, PR209, PR202, PR149 and combinations containing at least one thereof. It can also include combinations with other pigments included.

In a preferred embodiment, the colored master batch is selected from the group consisting of cyan, magenta and yellow primary color master batch. This means any combination of cyan, magenta and yellow primary color master batches, including only one of these.

In a preferred embodiment, the colored master batch is a master batch selected from the group consisting of cyan, magenta, yellow and black primary color master batches.

In an alternative embodiment, the laminate is a colored laminate comprising the colored thermoplastic interlayer and at least one other layer selected from the group consisting of rigid sheets, optional interlayer sheets, and film layers.

The invention is also directed to a colored master batch comprising:
(a) about 50 to about 80 wt % (based on the total weight of the colored master batch) of (i) ionomer copolymer of an alpha-olefin and about 15 to about 30 wt % (based on the total weight of the ionomer copolymer) of an alpha, beta-ethylenically unsaturated carboxylic acid, wherein about 5 to about 90% of the carboxylic acids are neutralized with a metal ion; and
(b) about 20 to about 50 wt % (based on the total weight of the colored master batch) pigment.

The master batch can contain 0 to 5 weight %, preferably 0 to 2% additives.

The colored master batch of claim preferably comprises about 55 to about 75 wt % of ionomer copolymer and about 35 to about 45 wt % pigment. In a preferred embodiment, the pigment is selected from the group consisting of (Color Index nomenclature) PB 60, PR202, PR264, PY151, PB 15.3, PR 122, PV 19, PY181, PV19, PR254, PV 15.1, PG 7, PB29, PB15.6, PY129, PY109, PY42, PB7, PB15:4, DPP/QA pigment, PR209, PR202, PR149 and combinations thereof. Preferably the pigment is selected from the group consisting of PY42, PB7, PB15:4, DPP/QA pigment, PR209, PR202, PR149 and combinations containing at least one thereof. It can also include combinations with other pigments included.

The invention is further directed to a transparent, colored thermoplastic interlayer sheet comprising about 97 to about 99.9 wt % (based upon the weight of the thermoplastic ionomer copolymer and pigment in the interlayer composition) thermoplastic ionomer copolymer and about 0.01 to about 3 wt % (based upon the weight of the thermoplastic ionomer copolymer and pigment in the interlayer) pigment, wherein the thermoplastic ionomer copolymer is thermoplastic copolymer of an alpha-olefin having 2 to 10 carbon atoms and about 15 to about 30 wt % (based on the total weight of the ionomer copolymer) of an alpha, beta-ethylenically unsaturated carboxylic acid having 3 to 8 carbons, wherein about 5 to about 90% of the carboxylic acids are neutralized with a metal ion, wherein the interlayer sheet has about 90 to 100% (preferably 95 to 100%) clarity. (ASTM D1003.)

A transparent laminate comprising a colored thermoplastic interlayer sheet and a rigid sheet, the colored thermoplastic interlayer sheet comprising about 97 to about 99.9 wt % (based upon the weight of the thermoplastic ionomer copolymer and pigment in the interlayer composition) thermoplastic ionomer copolymer and about 0.01 to about 3 wt % (based upon the weight of the thermoplastic ionomer copolymer and pigment in the interlayer) pigment, wherein the thermoplastic ionomer copolymer is thermoplastic copolymer of an alpha-olefin having 2 to 10 carbon atoms and about 15 to about 30 wt % (based on the total weight of the ionomer copolymer) of an alpha, beta-ethylenically unsaturated carboxylic acid having 3 to 8 carbons, wherein about 5 to about 90% of the carboxylic acids are neutralized with a metal ion, wherein the laminate has about 90 to 100% (preferably 95 to 100%) clarity. (ASTM D1003.)

### DETAILED DESCRIPTION OF THE INVENTION

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Although methods and materials similar or equivalent to those described herein can be used in the practice or testing of the present invention, suitable methods and materials are described herein.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. “A ‘consisting essentially of’ claim occupies a middle ground between closed claims that are written in a ‘consisting of’ format and fully open claims that are drafted in a ‘comprising’ format.”

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Use of “a” or “an” are employed to describe elements and components of the invention. This is done merely for convenience and to give a general sense of the invention. This description should be read to include one or at least one and the singular also includes the plural unless it is obvious that it is meant otherwise.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

The materials, methods, and examples herein are illustrative only and, except as specifically stated, are not intended to be limiting.

In one embodiment, the present invention is a colored master batch with well dispersed pigment particles to provide highly transparent and low haze colored articles.

Ionomer Copolymer

By “thermoplastic ionomer polymer”, ionomer polymer, ionomeric polymer, ionomer, and similar terms used herein, reference is made to thermoplastic ionomer copolymer made from an alpha-olefin and about 15 to about 30 wt % of an alpha, beta-ethylenically unsaturated carboxylic acid having 3 to 8 carbons, based on the total weight of the ionomer copolymer wherein about 5 to about 90% of the carboxylic acids are neutralized with a metal ion. Preferably, the copolymer comprises about 18 to about 25 wt %, or more preferably, about 18 to about 23 wt %, of groups from the alpha, beta-ethylenically unsaturated carboxylic acid, based on the total weight of the copolymer.

The alpha olefin comonomers preferably incorporate from 2 to 10 carbon atoms. Preferable alpha olefins include, but are not limited to, ethylene, propylene, 1-butene, 1-pentene, 1-hexene, 1-heptene, 3-methyl-1-butene, 4-methyl-1-pentene, and the like and mixtures thereof. More preferably, the alpha olefin is ethylene.

The preferred alpha, beta-ethylenically unsaturated carboxylic acid comonomers include acrylic acid, methacrylic acid, itaconic acid, maleic acid, maleic anhydride, fumaric acid, monomethyl maleic acid, and mixtures thereof. Most preferred are acrylic acid, methacrylic acid and mixtures thereof.

Frequently the ionomer copolymers are described with respect to the melt index (MI) of the parent acid copolymers since this property is indicative of the molecular weight of the polymer, and since the melt index of the ionomer copolymers is impacted by the level and type of neutralization and thus is not always useful to compare the polymer molecular weight. The best way to determine the MI of the acid copolymer is to measure the value directly by analyzing the acid copolymer prior to neutralization. However, acid copolymer MI of an ionomer can also be estimated through correlation to other similar polymers or by reacidifying the ionomer to form the acid copolymer and testing the resulting acid copolymer. The parent acid copolymers preferably have a melt index (MI) of about 1 to about 60 grams/10 min as measured by ASTM D1238 at 190° C. using a 2160 g. (A similar ISO test is ISO 1133.) More preferably, the parent acid copolymer has a MI of less than about 50 grams/10 min, even more preferably has a MI of less than about 40 grams/10 min, and most preferably has a MI of about 30 grams/10 min or less. These ionomer copolymers are relatively tough, which is especially desirable since they are utilized in interlayers for safety laminates.

The parent acid copolymers may be polymerized as disclosed in U.S. Pat. No. 3,404,134; U.S. Pat. No. 5,028,674; U.S. Pat. No. 6,500,888; and U.S. Pat. No. 6,518,365.

The ionomer copolymers are neutralized from about 5 to about 90%, or preferably, from about 10 to about 50%, or more preferably, from about 20 to about 40%, with metallic ions, based on the total carboxylic acid content of the copolymers as calculated for the non-neutralized copolymers.

The metallic ions may be monovalent, divalent, trivalent, multivalent, or mixtures therefrom. Useful monovalent metallic ions include, but are not limited to, sodium, potassium, lithium, silver, mercury, copper, and the like and mixtures thereof. Useful divalent metallic ions include, but are not limited to, beryllium, magnesium, calcium, strontium, barium, copper, cadmium, mercury, tin, lead, iron, cobalt, nickel, zinc, and the like and mixtures therefrom. Useful trivalent metallic ions include, but are not limited to, aluminum, scandium, iron, yttrium, and the like and mixtures therefrom. Useful multivalent metallic ions include, but are not limited to, titanium, zirconium, hafnium, vanadium, tantalum, tungsten, chromium, cerium, iron, and the like and mixtures therefrom. It is noted that when the metallic ion is multivalent, complexing agents, such as stearate, oleate, salicylate, and phenolate radicals are included, as disclosed within U.S. Pat. No. 3,404,134. The metallic ions are preferably monovalent or divalent metallic ions. More preferably, the metallic ions are selected from the group consisting of sodium, lithium, magnesium, zinc, and mixtures therefrom. Yet more preferably, the metallic ions are selected from the group consisting of sodium, zinc, and mixtures therefrom. The parent acid copolymers may be neutralized as disclosed in U.S. Pat. No. 3,404,134.

The ionomer copolymers may optionally contain other unsaturated comonomers. Specific examples of other unsaturated comonomers include, but are not limited to, methyl acrylate, methyl methacrylate, ethyl acrylate, ethyl methacrylate, isopropyl acrylate, isopropyl methacrylate, butyl acrylate, butyl methacrylate and mixtures thereof. In general, the ionomeric copolymers may incorporate 0 to about 50 wt %, or preferably, 0 to about 30 wt %, or more preferably, 0 to about 20 wt %, of the other unsaturated comonomer(s), based on the total weight of the copolymer.

A preferred example of a thermoplastic ionomer polymer is a poly(ethylene-co-methacrylic acid) partially neutralized with a metal ion, such as are selected from the group consisting of sodium, lithium, magnesium, zinc, and mixtures thereof.

Acid Copolymers

In addition to referring to acid copolymers with respect to the description of the ionomer copolymers, below applicants refer to “acid copolymers” in describing certain interlayers and carrier polymers. Such reference is to copolymers of an alpha-olefin and about 15 to about 30 wt % of an alpha, beta-ethylenically unsaturated carboxylic acid based on the total weight of the acid copolymer that are not neutralized. (In the case of an ionomer copolymer about 5 to about 90% of the carboxylic acids are neutralized with a metal ion, so by reference to there acid copolymers not being neutralized the presence of a very small or insignificant amount of a metal ion should not be considered to keep something from being considered an acid copolymer.) These copolymers can have all the same features as the ionomers as described herein, except that they are not neutralized. Thus, for instance, they can be made with the monomers described above and the preferred monomers, ratios, etc., are the same as those described above, and the preferred copolymers are made from an alpha olefin (or mixtures thereof) containing 2 to 10 carbon atoms, preferably ethylene, and about 15 to about 30 wt % (based on the total weight of the copolymer) of an alpha, beta-ethylenically unsaturated carboxylic acid having 3 to 8 carbons, preferably acrylic acid, methacrylic acid and mixtures thereof. Hence, poly(ethylene-co-methacrylic acid) is a preferred acid copolymer.

Pigments

It is believed that any known pigment can be utilized. Preferably, the pigments have high fade resistance when exposed to sunlight (color fastness) and high thermal stability, to reduce color changes under melt compounding processing conditions. In addition, pigments should be of the type that can be reduced to small particle size so to generate low haze in the laminate.

Preferred are pigments selected from the group consisting of, utilizing Color Index nomenclature when possible, PB 60, such as CROMOPHTAL Blue A3R (Ciba Specialty Chemicals Corporation, Tarrytown, N.Y. (Ciba)); PR202, CROMOPHTAL Magenta P (Ciba); a PR264, such as IRGAZIN DPP Rubine TR (Ciba); PY151, such as VERSAL Yellow H4G (Synthesia, a. s., Czech Republic); PB 15.3, such as PV Fast Blue BG (Clariant Corporation, Charlotte, N.C. (Clariant)); PR 122, such as PV Fast Pink 122 (Clariant); PV 19, such as PV Fast Red E3B (Clariant); PY181, such as PV Fast Yellow H3R (Clariant); PR254, such as VERSAL D3G (Clariant); PV 15.1, such as HELIOGEN Blue K 6911 D (BASF Corporation, Florham Park, N.J. (BASF)); PG 7, such as PV Fast Green GNX (Clariant); PB29, such as Ultramarine Blue (Nubiola, Barcelona, Spain); PB15.6, such as HELIOGEN Blue L6700 F (BASF); PY129, such as IRGAZIN Yellow 5GLT and IRGAZIN Yellow 5GT (Ciba); PY109, such as IRGAZIN Yellow 2GLTE (Ciba); PY42, such as SICOTRANS Yellow L1915 (BASF); PB7, such as RAVEN 2500 Ultra Carbon Black (Columbian Chemicals Company, Marietta, Ga.); PB15:4, such as ENDUROPHTHAL Blue GF BT617D (Clariant); DPP/QA, such as MONASTRAL Brilliant Red RT380D (Ciba); a PR209, such as HOSTAPERM EG Trans (Clariant); a PR202, such as SUNFAST Magenta 228-1215 (Sun Chemical Corporation, Parsippany, N.J. (Sun)); a PR149, such as SUN 264-0414 Fast Red BL (Sun); and mixtures thereof. Most preferably, the pigments are selected from the group consisting of, utilizing Color Index nomenclature, PY42, PB7, PB15:4, DPP/QA, PR209, PR202, PR149, and mixtures thereof.

Using the process of this invention little or no pigment agglomerates should be found in the laminates and, when present, agglomerates should be extremely small. This provides the high percent clarity desired for transparent safety glass laminates.

Colored Master Batch

The colored master batch comprises about 20 to about 50 wt % pigments dispersed within about 80 to about 50 wt % of a matrix thermoplastic polymer. Preferably, the colored master batch comprises about 35 to about 45 wt % pigments, more preferably about 35 to about 45 wt % pigments, dispersed within about 70 to about 50 wt %, more preferably about 65 to about 55 wt %, of a matrix thermoplastic polymer.

The pigments in the colored master batch may be one pigment or a combination of pigments. Preferably, the colored master batch comprises one pigment to form primary color master batches suitable in the production of color-matched compositions.

The matrix thermoplastic polymer can include any thermoplastic polymer that does not severely harm the performance of the ionomers when used as the matrix polymer in the master batch. Examples include polymers selected from the group consisting of acid copolymers, ionomers, poly(ethylene-co-vinyl acetate), poly(vinyl acetal) (e.g., poly(vinyl butyral)), polyurethane, polyvinylchloride, polyethylenes (e.g., linear low density polyethylenes), polyolefin block elastomers, ethylene acrylate ester copolymers (e.g., poly(ethylene-co-methyl acrylate) and poly(ethylene-co-butyl acrylate)), silicone elastomers and epoxy resins. Preferred are polymers selected from the group consisting of acid copolymers, ionomers, poly(ethylene-co-vinyl acetate), poly(vinyl butyral), linear low density polyethylenes (preferably metallocene-catalyzed), polyolefin block elastomers, and ethylene acrylate ester copolymers. Preferably, the matrix thermoplastic polymer is selected from the group consisting of poly(acetal) compositions, most preferably poly(vinyl butyral), acid copolymers and ionomers.

In one preferred embodiment, the matrix polymer is poly(vinyl butyral). The most preferred matrix thermoplastic polymer is a thermoplastic ionomer copolymer.

The pigments are dispersed in the thermoplastic matrix polymer. Dispersion, the process of deagglomerating the as-supplied pigment particles to primary particles, may be accomplished by any suitable means. The clarity of the articles containing the pigments, as demonstrated through haze measurements or percent transmittance measurements, for example, will suffer if the pigments are not sufficiently deagglomerated. Preferably, to provide the desired level of transparency the pigment primary particle diameter size is between about 1 to about 200 nanometers (nm), more preferably between about 10 to about 100 nm. However, it should be understood that the transparency of a pigment is a function of the pigment primary particle diameter size and other factors, such as, for example, the exact chemical composition of the pigment and the shape of the primary pigment particle.

The level of the pigments incorporated within the colored master batch is determining in providing the necessary melt viscosity to provide sufficient melt shear to deagglomerate the pigments to primary particles. The high level of pigments contained within the colored master batch are necessary to provide the high melt shears required to deagglomerate the pigments down to their primary particle size.

Preferably, the dispersion process is a high shear melt mixing process in which the molten thermoplastic matrix polymer is combined with the pigments and any optional components of the composition that may be present. Suitable high shear mixing equipment includes static mixers, rubber mills, Brabender mixers, Buss kneaders, single screw extruders, twin screw extruders, heated or unheated two-roll mills, and the like.

The precise processing conditions will depend on the physical properties of the thermoplastic matrix polymer, however, and on the amount and type of pigments and optional other ingredients to be incorporated into the colored master batch. Those of skill in the art will be able to determine appropriate processing conditions and equipment. Preferably, the processing temperature is between about 110 to about 250° C., more preferably between about 180 to about 250° C. For example, WO 01/00404 describes a method of dispersing pigments in a polymeric material using a heated two-roll mill. This method is more preferred when the colored master batch composition has a melt viscosity too high for efficient processing on other equipment, such as static mixers, rubber mills, Brabender mixers, Buss kneaders, single screw extruders, and twin screw extruders.

Color Concentrate

The color concentrate comprises about 90 to about 99 wt % (based on the total weight of the color concentrate) of the thermoplastic ionomer copolymer and about 1 to about 10 wt % (based on the total weight of the color concentrate) of pigment (total pigment). The pigment is obtained from one or more of the colored master batches. The color concentrate is produced through a melt compounding process, such as those described above, preferably through an extrusion melt compounding process. The color concentrate is produced through a process comprising (i) combining the matrix thermoplastic polymer and one or more master batches, followed by (ii) melt mixing above the melting point of the ionomer copolymer as described above. In a preferred embodiment, at least two or more colored master batches are used to provide the desired color concentrate.

Color concentrates provide greater control and accuracy in providing the desired final colored compositions based on the lowered pigment concentration.

The color concentrate may comprise one or more pigments. Preferably, the color concentrate comprises two or more pigments. Preferably each pigment is provided from separate colored master batches which incorporate one pigment (primary color master batches). More preferably, the color concentrate is made from the standard cyan, magenta and yellow (C-M-Y) pigment combinations and most preferably, the color concentrate comprises the standard cyan, magenta, yellow and black (C-M-Y-K) pigment combinations.

The color concentrate may also preferably be made from one or more colored master batch comprising one pigment or two or more pigments. Preferably, the color concentrate comprises one or more colored master batches which comprise one pigment (primary color colored master batches). The use of primary color colored master batches provides the flexibility in producing a wide range of color combinations and enables the ability to produce color matched compositions.

Interlayer Composition

The interlayer composition (sometimes referred to herein as the “color composition” or “color interlayer composition”) is made from an ionomer copolymer and one or more color concentrate, preferably one color concentrate. The interlayer composition comprises a total of about 0.01 to about 3 wt % pigment, preferably about 0.1 to about 2 wt % pigment, based on the weight of the interlayer composition. In a preferred embodiment, the interlayer composition comprises about 0.01 to about 0.5 weight % pigment, even more preferably about 0.01 to about 0.4 weight % pigment, based on the weight of the ionomer and pigment in the interlayer composition. (Since the interlayer is made from the interlayer composition, the same preferences apply to the interlayer sheets.) The color interlayer composition can be produced through the melt mixing processes described above, preferably through melt extrusion compounding processes.

To provide the desirable high transparency and low haze, it is preferable that the matrix thermoplastic polymer of the colored master batch is the ionomer copolymer. It is further more preferable that the ionomer copolymer used as the matrix thermoplastic polymer of the colored master batch and the ionomer copolymer used in the color concentrate have an alpha, beta-ethylenically unsaturated carboxylic acid level within 2 wt % of each other to enhance their miscibility and, in turn, provide even greater levels of the desirable high transparency and lower levels of haze. It is further preferable that the ionomer copolymer used in the color concentrate and the ionomer copolymer used in the color composition have an alpha, beta-ethylenically unsaturated carboxylic acid level within 2 wt % of each other to enhance their miscibility and, in turn, provide even greater levels of the desirable high transparency and lower levels of haze. It is most preferable that the ionomer copolymer used as the matrix thermoplastic polymer of the colored master batch, the ionomer copolymer used in the color concentrate and the ionomer copolymer used in the color composition have an alpha, beta-ethylenically unsaturated carboxylic acid level within 2 wt % of each other to enhance their miscibility and, in turn, provide even greater levels of the desirable high transparency and lower levels of haze.

Additives

It is understood that the compositions of the may be used with additives known within the art. The additives can include plasticizers, processing aides, flow enhancing additives, lubricants, flame retardants, impact modifiers, nucleating agents to increase crystallinity, antiblocking agents such as silica, thermal stabilizers, UV absorbers, UV stabilizers, dispersants, surfactants, chelating agents, coupling agents, adhesives, primers and the like. For example, dispersants, surfactants, chelating agents, and coupling agents may be included to improve the dispersability of the pigment particles. The person of ordinary skill in the art will recognize that additives may be added to the master batch, color concentrate and/or interlayer composition using techniques known in the art or variants thereof, and will know the proper amounts for addition based upon typical usage. Typically the total amount of additives used in an interlayer or interlayer composition is up to about 5 weight % (based upon the weight of the interlayer or interlayer composition, respectively), preferably 0 to about 2 weight %, and when added to the master batch or color concentrate the amounts will be based on the total amount desired in the interlayer or for processing.

Colored Polymeric Interlayer Sheets

The colored interlayer sheets can be produced by any suitable process. For example, the sheets may be formed through dipcoating, solution casting, compression molding, injection molding, melt extrusions, melt blowing, or any other procedures that are known to those of skill in the art. Preferably, the colored sheets disclosed herein are formed by melt extrusion, which is a particularly preferred process for formation of “endless” products.

As discussed above, the colored interlayer sheets are well-suited for use in safety laminates.

Preferably the colored interlayer sheets may take the form of single-layer interlayer sheet. By single-layer, it is meant that the sheet has only one single layer and that the single-layer is made of the color composition. However, one should not be confused by this term as “single-layer” interlayers sheets can be used in laminates that contain more than one interlayer either separated by rigid layers (e.g., glass), film, etc., or side-by-side with other like or dissimilar interlayer materials. In practical terms, a “single-layer” sheet is generally sold or distributed as an individual interlayer sheet. The key distinguishing feature of such a sheet is that by itself (particularly when intended for use in a safety laminate), the colored interlayer sheet has a total thickness of about 10 to about 250 mils (0.25-6.35 mm), preferably about 15 to about 90 mils (0.38-2.28 mm), and more preferably about 30 to about 90 mils (0.76-2.28 mm). Such an interlayer sheet, when used with appropriate glass in a properly designed laminate, should provide adequate penetration resistance commonly regarded as a feature of ionomer interlayer-containing safety laminates.

Typically such a colored interlayer should provide percent transmission (ASTM D1003) of about 20% to 100% transmission. (The preferred level of transmission will depend on the end-use.) In addition, it should provide percent clarity (ASTM D1003) about 90 to 100% clarity, preferably about 95 to 100, even more preferably about 98 to 100.

As discussed above, the colored sheets disclosed herein are useful in forming interlayer sheets in safety laminates. The colored sheets may take the form of single-layer or multilayer sheets. By “single-layer”, it is meant that the interlayer sheet has only one single layer made of the color interlayer composition. These can be used in combination with other interlayer sheets as described herein. By “multilayer”, it is meant that the interlayer sheet has two or more sub-layers and that at least one of the sub-layers is made of the color interlayer composition disclosed herein. The other sub-layer(s) of the multilayer film or sheet may be made of any suitable polymeric compositions. Preferably, however, the other sub-layer(s) is made of polymeric compositions selected from the group consisting of acid copolymers, ionomers, poly(ethylene-co-vinyl acetate), poly(vinyl acetal) (e.g., poly(vinyl butyral)), polyurethane, polyvinylchloride, polyethylenes (e.g., linear low density polyethylenes), polyolefin block elastomers, ethylene acrylate ester copolymers (e.g., poly(ethylene-co-methyl acrylate) and poly(ethylene-co-butyl acrylate)), silicone elastomers and epoxy resins. More preferably, the other sub-layers are formed of polymeric compositions selected from the group consisting of acid copolymers, ionomers, poly(ethylene-co-vinyl acetate), poly(vinyl butyral), linear low density polyethylenes (preferably metallocene-catalyzed), polyolefin block elastomers, and ethylene acrylate ester copolymers. Most preferred are ionomers and poly(vinyl butyral). Moreover, to provide adequate adhesion strength, at least one, or preferably, both, of the surface sub-layers of the multilayer film or sheet disclosed herein are formed of the color compositions disclosed herein.

When used as a safety laminate interlayer sheet, the colored interlayer sheet preferably has a total thickness of about 10 to about 250 mils (0.25-6.35 mm), or preferably, about 15 to about 90 mils (0.38-2.28 mm), or more preferably, about 30 to about 90 mils (0.76-2.28 mm) to ensure adequate penetration resistance commonly regarded as a feature of safety laminates. This thickness refers to the thickness of the single-layer sheet or the total thickness of a multiple layer interlayer sheet. Thus, in describing transparent laminates having one or more plies of colored ionomer interlayer preferably each of the interlayer sheets will have a thickness in the above range.

Typically interlayers are sold in sizes ranging from (all sizes are in inches) about 42 (106.7 cm) to about 144 (365.8 cm), such as 42×96 (243.9 cm), 42×108 (274.3 cm), 42×120 (304.8 cm), 48 (121.9 cm)×96, 48×108, 48×120, 60 (152.4 cm)×96, 60×120, 72 (182.9 cm)×96, 72×120, 84 (213.4 cm)×96, 84×108, 84×120, 84×144. Many other sizes are available and custom sizes are made as requested. Transparent laminates made with these interlayers can have the same or similar dimensions, or the interlayers can be cut or combined to provide other sizes.

The colored interlayer sheets disclosed herein may have smooth or roughened surfaces on one or both sides. Preferably, the colored sheets have roughened surfaces to facilitate the de-airing of the laminates through the laminate process. Providing channels for the escape of air and removing air during lamination is a known method for obtaining laminates having acceptable appearance. Roughened surfaces can be effected by mechanically embossing or by melt fracture during extrusion of the interlayer sheet or encapsulant film or sheet followed by quenching so that the roughness is retained during handling. The surface pattern can be applied to the colored sheet through common art processes. For example, the as extruded colored sheet may be passed over a specially prepared surface of a die roll positioned in close proximity to the exit of the die which imparts the desired surface characteristics to one side of the molten polymer. Thus, when the surface of such roll has minute peaks and valleys, film or sheet formed of polymer cast thereon will have a rough surface on the side which contacts the roll which generally conforms respectively to the valleys and peaks of the roll surface. Such die rolls are disclosed in, e.g., U.S. Pat. No. 4,035,549. Ionomer interlayer sheets having roughened or channeled surfaces are described in US 2003/0124296, US 2003/0124296 and U.S. patent application Ser. No. 11/725,622, filed Mar. 20, 2007.

If desired, one or both surfaces of the colored sheet disclosed herein may be treated to enhance the adhesion to other laminate layers. This treatment may take any form suitable for the desired end-use, including adhesives, primers, such as silanes, flame treatments (see, e.g., U.S. Pat. No. 2,632,921; U.S. Pat. No. 2,648,097; U.S. Pat. No. 2,683,894; and U.S. Pat. No. 2,704,382), plasma treatments (see e.g., U.S. Pat. No. 4,732,814), electron beam treatments, oxidation treatments, corona discharge treatments, chemical treatments, chromic acid treatments, hot air treatments, ozone treatments, ultraviolet light treatments, sand blast treatments, solvent treatments, and the like and combinations thereof. For example, a thin layer of carbon may be deposited on one or both surfaces of the film or sheet through vacuum sputtering as disclosed in U.S. Pat. No. 4,865,711. U.S. Pat. No. 5,415,942, on the other hand, discloses a hydroxy-acrylic hydrosol primer coating that may serve as an adhesion-promoting primer for poly(ethylene terephthalate) films.

The adhesive layer preferably can take the form of a monolayer of an adhesive primer or of a coating. The adhesive/primer coating may be about 0.0004 to about 1 mil (0.00001-0.03 mm), or preferably, about 0.004 to about 0.5 mil (0.0001-0.013 mm), or more preferably, about 0.004 to about 0.1 mil (0.0001-0.003 mm), thick. The adhesives may be any adhesive or primer known within the art. Preferably, the adhesives or primers are silane coupling agents or poly(vinyl amine) or poly(allyl amine). The poly(allyl amine)-based primers and their application to poly(ethylene terephthalate) polymeric films are disclosed within U.S. Pat. No. 5,411,845; U.S. Pat. No. 5,770,312; U.S. Pat. No. 5,690,994; and U.S. Pat. No. 5,698,329.

Laminates

The transparent laminates comprise a polymeric interlayer sheet formed of the color interlayer composition and a rigid layer. The laminates can comprise at least one other optional interlayer sheets and/or film layer.

The rigid sheets may be glass or rigid plastic sheets, such as, polycarbonate, acrylics, polyacrylate, cyclic polyolefins (e.g., ethylene norbornene polymers), polystyrene (preferably metallocene-catalyzed), polyamides, polyesters, fluoropolymers and the like and combinations thereof.

The term “glass” is meant to include not only window glass, plate glass, silicate glass, sheet glass, low iron glass, tempered glass, tempered CeO-free glass, and float glass, but also to include colored glass, specialty glass (such as those include ingredients to control, e.g., solar heating), coated glass (such as those sputtered with metals (e.g., silver or indium tin oxide) for solar control purposes), E-glass, Toroglass, Solex® glass (PPG Industries, Pittsburgh, Pa.). Such specialty glasses are disclosed in, e.g., U.S. Pat. No. 4,615,989; U.S. Pat. No. 5,173,212; U.S. Pat. No. 5,264,286; U.S. Pat. No. 6,150,028; U.S. Pat. No. 6,340,646; U.S. Pat. No. 6,461,736; and U.S. Pat. No. 6,468,934. It is understood, however, that the type of glass to be selected for a particular laminate depends on the intended use.

The other optional interlayer sheets may be formed of any suitable materials, such as, acid copolymers, ionomers, poly(ethylene-co-vinyl acetate), poly(vinyl acetal) (for example, poly(vinyl butyral)), polyurethane, polyvinylchloride, polyethylenes (e.g., linear low density polyethylenes (preferably metallocene-catalyzed)), polyolefin block elastomers, ethylene acrylate ester copolymers (e.g., poly(ethylene-co-methyl acrylate) and poly(ethylene-co-butyl acrylate)), silicone elastomers and epoxy resins. In one preferred embodiment, the other interlayer is a second polymeric film or sheet comprising an ionomeric composition. The thickness of the other optional interlayer sheet(s) is not critical and may be independently varied depending on the particular application, and is often within the preferred ranges described above for interlayer sheets. The values provided above for the acid copolymer layer are preferred in many instances.

The preferred level of transmission and clarity will depend on the end-use, and for many end-uses the laminates (a) preferably have percent transmission (ASTM D1003) of about 20% to 100% transmission, and (b) preferably have a percent clarity (ASTM D1003) of about 90 to 100% clarity, preferably about 95 to 100% clarity, and even more preferably about 98-100% clarity.

Polymeric film layers can be used in safety laminates. Preferable polymeric film materials include, but are not limited to, polyesters (e.g., poly(ethylene terephthalate) (PET)), poly(ethylene naphthalate), polycarbonate, polyolefins (e.g., polypropylene, polyethylene, and cyclic polyolefins), norbornene polymers, polystyrene (including syndiotactic polystyrene), styrene-acrylate copolymers, acrylonitrile-styrene copolymers, polysulfones (e.g., polyethersulfone, polysulfone, etc.), nylons, poly(urethanes), acrylics, cellulose acetates (e.g., cellulose acetate, cellulose triacetates, etc.), cellophane, vinyl chloride polymers (e.g., polyvinylidene chloride, vinylidene chloride copolymers, etc.), fluoropolymers (e.g., polyvinyl fluoride, polyvinylidene fluoride, polytetrafluoroethylene, ethylene-tetrafluoroethylene copolymers, etc.) and the like. More preferably, the polymeric film is a polyester film, and most preferably it is a biaxially oriented poly(ethylene terephthalate) (PET) film.

The thickness of the polymeric film is not critical and may be varied depending on the particular application. In general, however, the thickness of the polymeric film may range from about 0.1 mils (0.003 mm) to about 10 mils (0.26 mm), or preferably, from about 1 mil (0.025 mm) to about 7 mils (0.18 mm).

In addition, the polymeric films are sufficiently stress-relieved and shrink-stable under the coating and lamination processes. Preferably, the polymeric films are heat stabilized to provide low shrinkage characteristics when subjected to elevated temperatures (i.e. less than 2% shrinkage in both directions after 30 min at 150° C.).

The films may also be coated if desired. For example, the films may be coated with organic infrared absorbers and sputtered metal layers, such as silver, coatings and the like. Metal coated polymeric films are disclosed in, e.g., U.S. Pat. No. 3,718,535; U.S. Pat. No. 3,816,201; U.S. Pat. No. 4,465,736; U.S. Pat. No. 4,450,201; U.S. Pat. No. 4,799,745; U.S. Pat. No. 4,846,949; U.S. Pat. No. 4,954,383; U.S. Pat. No. 4,973,511; U.S. Pat. No. 5,071,206; U.S. Pat. No. 5,306,547; U.S. Pat. No. 6,049,419; U.S. Pat. No. 6,104,530; U.S. Pat. No. 6,204,480; U.S. Pat. No. 6,255,031; and U.S. Pat. No. 6,565,982. For example, the coating may function as oxygen and moisture barrier coatings, such as the metal oxide coating disclosed within U.S. Pat. No. 6,521,825; U.S. Pat. No. 6,818,819; and EP 1 182 710.

If desired, one or both surfaces of laminate layers, such as the colored interlayer sheet(s), the optional other interlayer sheet(s) or film layer(s), or the rigid sheet(s), may be treated to enhance their adhesion strength. For instance, it is preferable to use poly(alkyl amine) (preferably poly(allyl amines)) to adhere ionomers to polyester films. Similarly, silanes (e.g., aminosilanes) and poly(alkyl amines) (preferably, (vinyl amine), poly(allyl amine) and mixtures thereof) are sometimes used to coat glass to improve bonding to interlayers.

Preferably, the colored interlayer sheet is self-adhered to the glass. As used herein, when the a polymeric sheet is said to be “self-adhered” to the glass, it is meant that there is no intermediate layer such as a primer or thin adhesive layer between the glass and the polymeric layer, nor has the surface of the glass or polymeric layer been specially treated. A more preferred embodiment is a laminate comprising two layers of glass and at least one layer of the colored sheets bonded in between. Preferably, the colored sheet is self-adhered to one or both of the glass sheets or layers.

The safety laminate may take any form known within the art. Preferable specific glass laminate constructions include, for example, wherein “CIS” means the color interlayer sheet,

glass/CIS;

glass/CIS/film;

glass/CIS/glass;

film/CIS/film;

glass/CIS/film/CIS/glass;

glass/CIS/film/CIS/film;

and the like.

The safety laminates may be produced by any of the lamination process that are described below in detail, or by other processes.

Lamination Process

Any lamination process known within the art may be used. The lamination process may be an autoclave or non-autoclave process.

In an exemplary process, a glass sheet, a colored interlayer sheet and a second glass sheet are laid up and laminated together under heat and pressure and a vacuum (for example, in the range of about 27-28 inches (689-711 mm) Hg) to remove air. Preferably, the glass sheet has been washed and dried. A typical glass type is 2.5 mm thick clear annealed float glass. Preferably, the tin side of the float glass in contact with the colored interlayer sheet. The pre-laminate assembly is placed into a bag capable of sustaining a vacuum (“a vacuum bag”), drawing the air out of the bag using a vacuum line or other means of pulling a vacuum on the bag, sealing the bag while maintaining the vacuum, placing the sealed bag in an autoclave at a temperature of about 100 to about 180° C., preferably about 120 to about 160° C., more preferably of about 135 to about 155° C., at a pressure of about 150 to about 250, preferably about 200 psig (about 15 bar), for about 10 to about 50 minutes, preferably for about 20 to about 45 minutes and more for about 20 to about 40 minutes. A vacuum ring may be substituted for the vacuum bag. One type of vacuum bags is disclosed within U.S. Pat. No. 3,311,517. Following the heat and pressure cycle, the air in the autoclave is cooled without adding additional gas to maintain pressure in the autoclave. After about 20 minutes of cooling, the excess air pressure is vented and the laminates are removed from the autoclave.

An alternative process is a nip roll process for producing a prepress assembly. In one such process, the glass/colored interlayer sheet/glass assembly is heated in an oven at or to between about 80° C. and about 120° C., preferably between about 90° C. and about 100° C., for about 30 minutes. Thereafter, the heated glass/colored interlayer sheet/glass assembly is passed through a set of nip rolls so that the air in the void spaces between the glass and the interlayer is expelled. The edges of the structure are sealed at this point to produce a pre-press assembly that may be processed under vacuum in an autoclave, as described above, to produce a laminate.

The laminates of may also be produced through non-autoclave processes. A non-autoclave lamination process has been disclosed, e.g., within U.S. Pat. No. 3,234,062; U.S. Pat. No. 3,852,136; U.S. Pat. No. 4,341,576; U.S. Pat. No. 4,385,951; U.S. Pat. No. 4,398,979; U.S. Pat. No. 5,536,347; U.S. Pat. No. 5,853,516; U.S. Pat. No. 6,342,116; U.S. Pat. No. 5,415,909; US 2004-0182493; US 2003-0148114 A1; EP 1 235 683 B1; WO 91/01880; and WO 03/057478 A1. Generally, the non-autoclave process includes heating the pre-laminate assembly or the pre-press assembly and, optionally, the application of vacuum, pressure or both. For example, the pre-press may be successively passed through heating ovens and nip rolls. A commercial example of a lamination process includes the Icolam vacuum laminating systems of Meier Vakuumtechnik GmbH, Bocholt, Germany).

### EXAMPLES

The following polymers were used in the examples:

Ionomer #1 was a poly(ethylene-co-methacrylic acid) made with 22 weight % methacrylic acid and partially neutralized with approximately 27% sodium ion with an MI of approximately 2 (2160 g, 190° C., ISO 1133, ASTM D1238).

Ionomer #2 was a poly(ethylene-co-methacrylic acid) made with 19 weight % methacrylic acid and partially neutralized with 37% sodium ion neutralized with sodium ions, with an MI of 2.

PVB was a medium viscosity grade of poly(vinyl butyral) with a hydroxyl number of 18 to 18.5.

Reference below to a Brabender extruder, is to compounding in a Brabender extruder with an extruder head, a 25:1 L/d single screw (0.75 inch diameter). The Brabender extruder was operated with a temperature profile of: feed zone 110° C.; Section 1 190° C.; Section 2 190° C.; and die plate 200° C. at a screw speed of 40 rpm.

Unless otherwise noted, laminates measurements for (a) percent transmission were according to ASTM D1003, (b) percent haze were according to ASTM D1003 on a BKY Gardner HAZEGARD Plus (BYK Gardner Corporation, BYK-Chemie GmbH, Wesel, Germany), and (c) laboratory color were made on a Hunterlab ULTRASCAN XE (Hunter Associates Laboratory, Inc., Reston, Va.) using 10 degrees/D65 illuminant/observer, and (d) percent clarity were according to ASTM D1003.

Unless otherwise noted, laminates were subjected to peel adhesion testing with a peel angle of 180 degrees and a crosshead speed of 100 mm/min.

### Example 1

A composition was prepared which incorporated 40 weight % of Columbian RAVEN 2500 Ultra Carbon Black (Columbian Chemicals Company, Marietta, Ga.), and 60 weight % of Ionomer #1. The resulting powder composition was mixed to form a powder blend. The resulting powder blend was subjected to high shear, intensive melt mixing on a two roll mill heated to a temperature within the range of 180° C. to 200° C. for 30 minutes. The resulting slabs were cooled to room temperature and then crushed to form discrete chips.

### Example 2

A composition was prepared which incorporated 40 weight % of Clariant ENDUROPTHAL Blue GF BT617D (Clariant Corporation, Charlotte, N.C.)), and 60 weight % of Ionomer #1. The resulting powder composition was processed as in Example 1 to form discrete chips.

### Example 3

A composition was prepared which incorporated 40 weight % of Sun SUNFAST Magenta 228-1215 (the Sun Chemical Corporation, Parsippany, N.J.)), and 60 weight % of Ionomer #1. The resulting powder composition was processed as in Example 1 to form discrete chips.

### Example 4

A color concentrate was prepared by combining 0.82 weight % of the colored master batch prepared above in Example 1, 0.82 weight % of the colored master batch prepared above in Example 2, 0.36 weight % of the colored master batch prepared above in Example 3, and 98 weight % of Ionomer #1. The resulting pellet blend was tumbled and extrusion compounded at a temperature of 190° C. on a 28 mm single screw extruder.

### Example 5

A gray resin was produced by melt compounding a blend of the gray pigment concentrate from Example 4, above (4.84 weight % based on polymer (bop)), and TINUVIN 328 (0.8 weight % bop, Ciba) with Ionomer #1, through a Werner-Pfleider twin screw extruder (28 mm diameter, counter-rotating) with a screw speed of 200 rpm and the temperature profile described below;

| Feed | Ambient |
|---|---|
| Zone 1 | 150° C. |
| Zone 2 | 160° C. |
| Zone 3 | 180° C. |
| Zone 4 | 200° C. |
| Zone 5 | 200° C. |
| Zone 6 | 200° C. |
| Die | 200° C. |

The compounded gray resin was extruded through a 2-hole die ( 3/16-inch diameter) into a water quench trough and subsequently cut into pellets.

### Example 6

The interlayer composition prepared in Example 5 was cast into sheet on a film casting line fed by a single screw Killion extruder (1.5-inch diameter). Throughput was controlled by adjusting the screw speed to 70 rpm. The extruder temperature profile is described below.

| Feed | Ambient |
|---|---|
| Zone 1 | 160° C. |
| Zone 2 | 200° C. |
| Zone 3 | 200° C. |
| Block | 210° C. |
| Die | 210° C. |

A 14-inch wide “coathanger” die with a nominal die gap of 0.038 inch was used and the gray sheet was cast into a three roll stack consisting of a 6-inch diameter rubber nip roll covered with a TEFLON release film and two 12-inch diameter polished chrome chill rolls held at a temperature of between 10 and 15° C. After edge trimming, 12 inch wide (305 mm), 30 mil (0.76 mm) thick interlayer sheets were collected, cut into about 40 inch lengths and sealed under vacuum in foil lined packages.

### Example 7

Glass laminates composed of a glass layer, a gray interlayer sheet from Example 6, above, and an AKASOL PTL 3-38/75 film layer (defined as a 7 mils thick (180 micrometers) PVF/PET/PVF+Primer film, Krempel, August Krempel Soehne, Vertriebsgesellschaft m. b. H. Wien, Wien, Austria), were produced in the following manner. The samples were laid up with a clear annealed float glass plate layer (4 inches by 4 inches (100 mm×100 mm) by 2.18 mm thick) with a 1 inch wide strip of MYLAR 880 poly(ethylene terephthalate) film (5 mils thick (0.13 mm), DuPont Teijin Films Corporation, Hopewell, Va.), or a 584-A polyester flash tape (2 mils thick (0.05 mm), Fibre Glast Developments Corporation, Brookville, Ohio), placed on one glass edge, a gray sheet layer from Example 6, above (4 inches by 4 inches (100 mm×100 mm) by 30 mils (0.76 mm) thick, with the gray sheet in contact with the tin side of the float glass), an AKASOL PTL 3-38/75 film layer (4 inches by 4 inches (100 mm×100 mm) by 7 mils (180 micrometers) thick), and a clear annealed float glass cover plate layer (4 inches by 4 inches (100 mm×100 mm) by 2.18 mm thick). The glass/interlayer/film/glass assembly was then placed into a vacuum bag, the vacuum bag was evacuated to a vacuum of 3 in. Hg, and heated to 130-135° C. for 60 minutes. The vacuum was then released and heating was discontinued and the laminate was allowed to cool to room temperature. Removal of the glass cover plate provided the desired glass/interlayer/AKASOL PTL 3-38/75 film laminate.

The laminates were found to have an average glass-interlayer peel adhesion of 23.74 lbf/in of six laminates.

### Example 8

Glass laminates composed of a glass layer, a gray interlayer sheet from Example 6, and an AKASOL PTL 3-38/75 film layer, were produced in the following manner. The samples were laid up with a low iron STARFIRE glass plate layer (4 inches by 4 inches (100 mm×100 mm) by 3.15 mm thick, PPG Industries, Pittsburgh, Pa., USA), with a 1 inch wide strip of MYLAR 880 poly(ethylene terephthalate) film (5 mils thick (0.13 mm)), or a 584-A polyester flash tape (2 mils thick (0.05 mm)), placed on one glass edge, a gray sheet layer from Example 6 (4 inches by 4 inches (100 mm×100 mm) by 30 mils (0.76 mm) thick, with the gray sheet in contact with the tin side of the glass), an AKASOL PTL 3-38/75 film layer (4 inches by 4 inches (100 mm×100 mm) by 7 mils (180 micrometers) thick, and a clear annealed float glass cover plate layer (4 inches by 4 inches (100 mm×100 mm) by 2.18 mm thick). The glass/interlayer/film/glass assembly was heated under vacuum in a vacuum bag as in Example 7 to provide the desired glass/interlayer/AKASOL PTL 3-38/75 film laminate.

The laminates were found to have an average glass-interlayer peel adhesion of 14.44 lbf/in of six laminates.

### Example 9

Glass laminates composed of a glass layer, a gray sheet from Example 6 and a polyester film layer were produced in the following manner. The samples were laid up with a clear annealed float glass plate layer (4 inches by 4 inches (100 mm×100 mm) by 2.18 mm thick) with a 1 inch wide strip of MYLAR 880 poly(ethylene terephthalate) film (5 mils thick (0.13 mm)), or a 584-A polyester flash tape (2 mils thick (0.05 mm)), placed on one glass edge, a gray sheet layer from Example 6, above (4 inches by 4 inches (100 mm×100 mm) by 30 mils (0.76 mm) thick, with the gray sheet in contact with the tin side of the float glass), a MYLAR 880 film layer (4 inches by 4 inches (100 mm×100 mm) by 5 mils (0.13 mm) thick), and a clear annealed float glass cover plate layer (4 inches by 4 inches (100 mm×100 mm) by 2.18 mm thick). The glass/interlayer/film/glass assembly was then under vacuum in a vacuum bag as in Example 7 to provide the desired glass/interlayer/MYLAR 880 film laminate.

The laminates were found to have an average glass-interlayer peel adhesion of 9.85 lbf/in of six laminates.

### Example 10

Glass laminates composed of a glass layer, a gray sheet from Example 6 and an AKASOL PTL 3-38/75 film layer (7 mils thick (180 micrometers)), were produced in the following manner. Pre-laminates were produced from the samples as described in Example 8. The pre-laminate assembly was then placed within a Meier ICOLAM 10/08 laminator (Meier Vakuumtechnik GmbH, Bocholt, Germany). The lamination cycle included an evacuation step (vacuum of 3 in. Hg) of 8 minutes and a pressing stage (pressure of 1000 mb) of 4 minutes at a temperature of 155° C. Removal of the glass cover plate provided the desired glass/interlayer/AKASOL PTL 3-38/75 film laminate.

The laminates were found to have an average glass-interlayer peel adhesion of 5.92 lbf/in of three laminates.

### Example 11

Glass laminates composed of a glass layer, the colored interlayer from Example 6, and a glass layer were produced in the following manner. The samples were laid up with a clear annealed float glass plate layer (4 inches by 4 inches (102 mm×102 mm) by 2.3 mm thick), a colored plaque layer from Example 6 (4 inches by 4 inches (102 mm×102 mm) by 30 mil (0.79 mm), with the plaque layer in contact with the tin side of the glass sheets), and a clear annealed float glass plate layer (4 inches by 4 inches (102 mm×102 mm) by 2.3 mm thick). The glass/interlayer/glass assembly was then placed into a vacuum bag and heated to 90 to 100° C. for 30 minutes to remove any air contained between the glass/interlayer/glass assembly. The glass/interlayer/glass pre-press assembly was then subjected to autoclaving at 135° C. for 30 minutes in an air autoclave to a pressure of 200 psig (14.3 bar). The air was then cooled while no more air is added to the autoclave. After 20 minutes of cooling when the air temperature was less than about 50° C., the excess pressure was vented, and the glass/interlayer/glass laminate was removed from the autoclave.

The laminates were found to have 2.5% haze, and laboratory color of L* 66.04, a* −0.26 and b* −2.57.

### Preparative Example PE 1

A composition was prepared which incorporated 40 weight % of PY 42 pigment, 50 weight % PVB, and 10 weight % triethylene glycol bis(2-ethyl hexanoate). The resulting powder composition was mixed to form a powder blend. The resulting powder blend was subjected to high shear, intensive melt mixing on a two roll mill heated to a temperature within the range of 180° C. to 200° C. for 30 minutes. The resulting slabs were cooled to room temperature and then crushed to form discrete chips.

### Example 12

A pellet blend of 95 grams Ionomer #2 and 5 grams of the master batch from Preparative Example PE 1 was fed to a Brabender extruder and compounded. The resulting compounded blend was collected and fed back through the extruder twice more to produce a color concentrate.

A pellet blend of 99 grams Ionomer #2 and 1 gram of the color concentrate produced above was fed to a Brabender extruder and compounded. The resulting compounded blend was collected and fed back through the extruder twice more to produce an interlayer composition.

The interlayer composition produced above was pressed into 4 inches by 4 inches (102 mm×102 mm) by 32 mil (0.81 mm) plaques on a steam heated melt press with a cycle including a 3 minute heat up step at a pressure of 6000 psi, a 2 minute hold at 12,000 psi and a 4 minute cool down at 12,000 psi.

Glass laminates composed of a glass layer, the colored plaque layer from above, and a glass layer (glass/interlayer/glass laminates) were produced in the same manner as in Example 11

The laminates found to have 87.5% transmission, 7.85% haze, laboratory color of L* 93.43, a* −2.19 and b* 7.77, and 98.5% clarity.

### Preparative Example PE 2

Discrete chips were prepared in the same manner as in Preparative Example PE 1, except the pigment was PB 15:4 pigment.

### Example 13

A pellet blend of 95 grams Ionomer #2 and 5 grams of the master batch product from Preparative Example PE 2 was fed to a Brabender extruder and compounded. The resulting compounded blend was collected and fed back through the extruder twice more to form a color concentrate composition.

A pellet blend of 99 grams Ionomer #2 and 1 gram of the color concentrate composition was fed to a Brabender extruder and compounded. The resulting compounded blend was collected and fed back through the extruder twice more, to produce an interlayer composition.

The interlayer composition produced above was pressed into 4 inches by 4 inches (102 mm×102 mm) by 32 mil (0.81 mm) plaques as described in Example 12.

Glass laminates composed of a glass layer, the colored plaque layer from above, and a glass layer (glass/interlayer/glass laminate) were produced as described in Example 11.

The laminates were found to have 51.7% transmission, 2.48% haze, laboratory color of L* 77.44, a* −37.32 and b* −25.85, and 99.2% clarity.

### Comparative Example CE 1

This example is an example wherein a masterbatch is not produced or used.

A pellet blend of 98 grams Ionomer #2 and 2 grams PB 15:4 pigment was fed to a Brabender extruder and compounded. The resulting compounded blend was collected and fed back through the extruder twice more to prepare a color concentrate composition.

A pellet blend of 99 grams Ionomer 2 and 1 gram of the PB 15:4 pigment concentrate produced above was fed to a Brabender extruder and compounded. The resulting compounded blend was collected and fed back through the extruder twice more to form an interlayer composition.

The interlayer composition produced above was pressed into 4 inches by 4 inches (102 mm×102 mm) by 32 mil (0.81 mm) plaques as described in Example 12.

Glass laminates composed of a glass layer, the colored plaque layer from above, and a glass layer (glass/interlayer/glass laminate) were produced as described in Example 11.

The laminates were found to have 58.2% transmission, 6.06% haze, and 98.5% clarity. This example shows the reduced clarity and higher haze versus the invention.

### Preparative Example PE 3

A composition was prepared and discrete chips were formed as described in Preparative Example PE 1, except that the pigment was PR 209 pigment.

### Example 14

A pellet blend of 95 grams Ionomer #2 and 5 grams of the master batch from Preparative Example PE 3 was fed to a Brabender extruder and compounded. The resulting compounded blend was collected and fed back through the extruder twice more to form color concentrate.

A pellet blend of 99 grams of Ionomer #2 and 1 gram of the color concentrate produced above was fed to a Brabender extruder and compounded. The resulting compounded blend was collected and fed back through the extruder twice more to form interlayer composition.

The interlayer composition produced above was pressed into 4 inches by 4 inches (102 mm×102 mm) by 32 mil (0.81 mm) plaques on a steam heated melt press with the cycle described in Example 12.

Glass laminates composed of a glass layer, the colored plaque layer from above, and a glass layer (glass/interlayer/glass laminates) were produced in the same manner as in Example 11. The laminates were found to have 58.1% transmission, 15.0% haze, laboratory color of L* 80.52, a* 32.04 and b* −5.11, and 96.8% clarity.

### Preparative Example PE 4

A composition was prepared and discrete chips were formed as described in Preparative Example PE 1, except that the pigment was PB 7 pigment.

### Example 15

A pellet blend of 95 grams of Ionomer #2 and the 5 grams of the master batch prepared in Preparative Example PE 4 and compounded. The resulting compounded blend was collected and fed back through the extruder twice more to form a color concentrate.

A pellet blend of Ionomer #2 (99 grams) and the color concentrate (1 gram) was fed to a Brabender extruder and compounded. The resulting compounded blend was collected and fed back through the extruder twice more to form interlayer composition.

The interlayer composition was pressed into 4 inches by 4 inches (102 mm×102 mm) by 32 mil (0.81 mm), plaques on a steam heated melt press with a cycle described in Example 12.

Glass laminates composed of a glass layer, the colored plaque layer from above, and a glass layer (glass/interlayer/glass laminate) were produced as described in Example 11.

The laminates were found to have 33.1% transmission, 35.0% haze, laboratory color of L* 63.73, a* 0.24 and b* 5.12, and 98.1% clarity.

### Preparative Example PE 5

A gray ink dope solution comprising the master batch of Preparative Example PE 2 (3.0 grams), the master batch of Preparative Example PE 3 (9.8 grams), the master batch of Preparative Example PE 4 (7.2 grams), PVB (20 grams), and a 3:1 (by weight) solution of methanol:toluene (160 grams) was prepared. Drawdowns (films) were prepared using wire-wound rods. The dried films were chopped and used as a gray color masterbatch.

### Example 16

A pellet blend of an Ionomer #2 (300.0 grams) and the color masterbatch of Preparative Example PE 5 (0.19 grams) was fed to a Brabender Extruder and compounded. The resulting compounded blend was collected and fed back through the extruder twice more to form interlayer composition.

The interlayer composition was pressed into 4.5 inches by 9.5 inches (114.3 mm×241.3 mm) by 30 mil thick (0.76 mm) plaques on a melt press with a cycle including a 1.5 minute heat up step at a pressure of 650 psi, a 2 minute hold at 6000 psi and a 4 minute cool down at 6000 psi, with the set press temperature of 180° C.

### Example 17

A pellet blend of an Ionomer #2 (300.0 grams) and the color masterbatch of Preparative Example PE 5 (0.30 grams) was fed to a Brabender Extruder and compounded. The resulting compounded blend was collected and fed back through the extruder twice more to form interlayer composition.

The interlayer composition was pressed into 4.5 inches by 9.5 inches (114.3 mm×241.3 mm) by 30 mil thick (0.76 mm) plaques as described in Example 16.

1. A process for preparing a transparent laminate comprising a colored interlayer and a rigid sheet, comprising:
(a) forming a color concentrate comprising a thermoplastic ionomer copolymer and about 1 to about 10 wt % (based on the total weight of the color concentrate) of pigment by:
(i) combining (a) one or more colored master batch, each comprising about 50 to about 80 wt % (based upon the weight of the master batch) a thermoplastic matrix polymer and about 20 to about 50 wt % (based on the weight of the master batch) of pigment, and (b) one or more thermoplastic ionomer copolymer; and
(ii) melt mixing the one or more colored master batch and the one or more thermoplastic ionomer copolymer at a temperature above the melting points of the thermoplastic ionomer copolymer and the thermoplastic matrix polymer;
(b) forming an interlayer composition comprising about 97 to about 99.9 wt % (based upon the weight of the ionomer and pigment in the interlayer composition) thermoplastic ionomer copolymer and about 0.01 to about 3 wt % (based upon the weight of the thermoplastic ionomer copolymer and pigment in the interlayer composition) pigment by:
(i) combining the color concentrate and thermoplastic ionomer copolymer; and
(ii) melt mixing the color concentrate and the thermoplastic ionomer copolymer at a temperature above the melting point of the thermoplastic ionomer copolymer; and
(c) forming a colored thermoplastic interlayer sheet comprising about 97 to about 99.9 wt % (based upon the weight of the ionomer and pigment in the interlayer composition) thermoplastic ionomer copolymer and about 0.01 to about 3 wt % (based upon the weight of the ionomer and pigment in the interlayer) pigment by extruding the interlayer composition into the interlayer sheet; and
(d) preparing a laminate comprising the colored thermoplastic interlayer and a rigid sheet;
wherein by thermoplastic ionomer copolymer is meant a thermoplastic copolymer of an alpha-olefin having 2 to 10 carbon atoms and about 15 to about 30 wt % (based on the total weight of the ionomer copolymer) of an alpha, beta-ethylenically unsaturated carboxylic acid having 3 to 8 carbons, wherein about 5 to about 90% of the carboxylic acids are neutralized with a metal ion.

2. The process of claim 1 wherein the thermoplastic matrix polymer is a thermoplastic ionomer copolymer of an alpha-olefin having 2 to 10 carbon atoms and about 15 to about 30 wt % (based on the total weight of the ionomer copolymer) of an alpha, beta-ethylenically unsaturated carboxylic acid having 3 to 8 carbons, wherein about 5 to about 90% of the carboxylic acids are neutralized with a metal ion and wherein each of the melt mixing steps is conducted at a temperature from about 110° C. to about 250° C.

3. The process of claim 1 wherein the thermoplastic matrix polymer is poly(vinyl butyral) and wherein each of the melt mixing steps is conducted at a temperature from about 110° C. to about 250° C.

4. A process for preparing a transparent laminate comprising a colored interlayer and a rigid sheet, comprising:
(a) forming a color concentrate consisting essentially of (I) about 90 to about 99 wt % (based on the total weight of the ionomer and pigment in the color concentrate) of an thermoplastic ionomer copolymer, (II) about 1 to about 10 wt % (based on the total weight of the ionomer and pigment in the color concentrate) of pigment, and (III) 0 to about 5 wt % (based on the total weight of the color concentrate) optional additives by:
(i) combining (a) one or more colored master batch, each comprising about 50 to about 80 wt % (based upon the weight of the ionomer and pigment in the master batch) a thermoplastic ionomer copolymer and about 20 to about 50 wt % (based on the weight of the ionomer and pigment in the master batch) of pigment, and (b) one or more thermoplastic ionomer copolymer; and
(ii) melt mixing the one or more colored master batch and the one or more thermoplastic ionomer copolymer at a temperature above the melting point of the thermoplastic ionomer copolymer;
(b) forming an interlayer composition consisting essentially of (I) about 97 to about 99.9 wt % (based upon the weight of the ionomer and pigment in the interlayer composition) thermoplastic ionomer copolymer, (II) about 0.01 to about 3 wt % (based upon the weight of the ionomer and pigment in the interlayer composition) pigment, and (III) 0 to about 5 wt % (based on the total weight of the interlayer composition) optional additives by:
(i) combining the color concentrate and thermoplastic ionomer copolymer; and
(ii) melt mixing the color concentrate and the thermoplastic ionomer copolymer at a temperature above the melting point of the thermoplastic ionomer copolymer; and
(c) forming a colored thermoplastic interlayer sheet consisting essentially of (I) about 97 to about 99.9 wt % (based upon the weight of the ionomer and pigment in the interlayer) thermoplastic ionomer copolymer, (II) about 0.01 to about 3 wt % (based upon the weight of the ionomer and pigment in the interlayer) pigment by extruding the interlayer composition into the interlayer sheet, and (III) 0 to about 5 wt % (based on the total weight of the colored thermoplastic interlayer sheet of optional additives; and
(d) preparing a laminate comprising the colored thermoplastic interlayer and a rigid sheet;
wherein by thermoplastic ionomer copolymer is meant a thermoplastic copolymer of an alpha-olefin having 2 to 10 carbon atoms and about 15 to about 30 wt % (based on the total weight of the ionomer copolymer) of an alpha, beta-ethylenically unsaturated carboxylic acid having 3 to 8 carbons, wherein about 5 to about 90% of the carboxylic acids are neutralized with a metal ion.

5. The process of claim 1 wherein (a) the interlayer composition comprises about 0.1 to about 2 weight % pigment, based on the weight of the interlayer composition, (b) the colored interlayer comprises about 0.1 to about 2 weight % pigment, based on the weight of the colored thermoplastic interlayer, and (c) the color concentrate comprises about 0.3 to about 5 weight % pigment, based on the weight of the color concentrate.

6. The process of claim 1 wherein the pigment primary particle diameter size is between about 1 to about 200 nanometers (nm).

7. The process of claim 1 wherein the laminates have about 20% to 100% transmission.

8. The process of claim 1 wherein laminate has about 90 to 100% clarity.

9. The process of claim 7 wherein laminate has about 95 to 100% clarity.

10. The process of claim 4 wherein (a) the interlayer composition contains about 0.01 to about 0.5 weight % pigment, based on the weight of the ionomer and pigment in the interlayer composition, (b) the colored interlayer contains about 0.01 to about 0.5 weight % pigment, based on the weight of the ionomer and pigment in the colored interlayer.

11. The process of claim 1 wherein each of the melt mixing steps is conducted at a temperature from about 110° C. to about 250° C.

12. The process of claim 1 wherein each of the melt mixing steps are conducted at a temperature from about 180° C. to about 250° C.

13. The process of claim 1 wherein the colored interlayer is adhered directly to the rigid sheet.

14. The process of claim 1 wherein the rigid sheet is a glass sheet.

15. The process of claim 6 wherein the rigid sheet is a glass sheet.

16. The process of claim 1 wherein the preparing a laminate comprising the colored thermoplastic interlayer and a rigid sheet comprises forming a pre-laminate assembly of the colored thermoplastic interlayer between the rigid sheet and a second rigid sheet, and laminating the pre-laminate assembly using heat.

17. The process of claim 1 wherein the preparing a laminate comprising the colored thermoplastic interlayer and a rigid sheet comprises forming a pre-laminate assembly of the colored thermoplastic interlayer and at least one other interlayer sheet between the rigid sheet and a second rigid sheet, and laminating the pre-laminate assembly using heat.

18. The process of claim 1 wherein the laminate is formed by forming a pre-laminate assembly comprising in order the rigid sheet, the colored thermoplastic interlayer, a polyester film, a second interlayer sheet and a second rigid sheet, and laminating the pre-laminate assembly using heat.

19. The process of claim 1 wherein the laminate is formed by forming a pre-laminate assembly comprising in order the rigid sheet, the colored thermoplastic interlayer, a polyester film, and laminating the pre-laminate assembly using heat.

20. The process of claim 1 wherein the colored thermoplastic interlayer is in the form of a monolayer sheet with a thickness of about 10 to about 250 mils (0.25-6.35 mm).

21. The process of claim 1 wherein the thermoplastic ionomer copolymer is prepared from (a) an alpha olefin selected from the group consisting of ethylene, propylene, 1-butene, 1-pentene, 1-hexene, 1-heptene, 3-methyl-1-butene, 4-methyl-1-pentene and mixtures thereof, and (b) an alpha, beta-ethylenically unsaturated carboxylic acid comonomer selected from the group consisting of acrylic acid, methacrylic acid, itaconic acid, maleic acid, maleic anhydride, fumaric acid, monomethyl maleic acid and mixtures thereof.

22. The process of claim 1 wherein the thermoplastic ionomer copolymer is prepared from (a) ethylene and (b) acrylic acid, methacrylic acid or mixtures thereof.

23. The process of claim 1 wherein the pigment is selected from the group consisting of PB 60, PR202, PR264, PY151, PB 15.3, PR 122, PV 19, PY181, PV19, PR254, PV 15.1, PG 7, PB29, PB15.6, PY129, PY109, PY42, PB7, PB15:4, DPP/QA pigment, PR209, PR202, PR149 and combinations thereof.

24. The process of claim 1 wherein the pigment is selected from the group consisting of PY42, PB7, PB15:4, DPP/QA pigment, PR209, PR202, PR149 and combinations containing at least one thereof.

25. The process of claim 1 wherein the colored master batch is selected from the group consisting of cyan, magenta and yellow primary color master batch.

26. The process of claim 1 wherein the colored master batch is a master batch selected from the group consisting of cyan, magenta, yellow and black primary color master batches.

27. A colored master batch comprising:
(a) about 50 to about 80 wt % (based on the total weight of the colored master batch) of (i) an ionomer copolymer of an alpha-olefin and about 15 to about 30 wt % (based on the total weight of the ionomer copolymer) of an alpha, beta-ethylenically unsaturated carboxylic acid, wherein about 5 to about 90% of the carboxylic acids are neutralized with a metal ion; and
(b) about 20 to about 50 wt % (based on the total weight of the colored master batch) pigment.

28. A transparent, colored thermoplastic interlayer sheet comprising about 97 to about 99.9 wt % (based upon the weight of the thermoplastic ionomer copolymer and pigment in the interlayer composition) thermoplastic ionomer copolymer and about 0.01 to about 3 wt % (based upon the weight of the thermoplastic ionomer copolymer and pigment in the interlayer) pigment, wherein the thermoplastic ionomer copolymer is thermoplastic copolymer of an alpha-olefin having 2 to 10 carbon atoms and about 15 to about 30 wt % (based on the total weight of the ionomer copolymer) of an alpha, beta-ethylenically unsaturated carboxylic acid having 3 to 8 carbons, wherein about 5 to about 90% of the carboxylic acids are neutralized with a metal ion, wherein the interlayer sheet has about 90 to 100% clarity.

29. A transparent laminate comprising a colored thermoplastic interlayer sheet and a rigid sheet, the colored thermoplastic interlayer sheet comprising about 97 to about 99.9 wt % (based upon the weight of the thermoplastic ionomer copolymer and pigment in the interlayer composition) thermoplastic ionomer copolymer and about 0.01 to about 3 wt % (based upon the weight of the thermoplastic ionomer copolymer and pigment in the interlayer) pigment, wherein the thermoplastic ionomer copolymer is thermoplastic copolymer of an alpha-olefin having 2 to 10 carbon atoms and about 15 to about 30 wt % (based on the total weight of the ionomer copolymer) of an alpha, beta-ethylenically unsaturated carboxylic acid having 3 to 8 carbons, wherein about 5 to about 90% of the carboxylic acids are neutralized with a metal ion, wherein the laminate has about 90 to 100% clarity.
